(19) United States
(12) Patent Application Publication
(10) Pub. No.: US 2004/0011623 A1
(43) Pub. Date: Jan. 22, 2004

(54) Automatic linear machine for orienting and aligning articles

(76) Inventor: Jaime Marti Sala, Barcelona (ES)

Correspondence Address: JACOBSON HOLMAN PLLC, 400 SEVENTH STREET N.W., SUITE 600, WASHINGTON, DC, 20004, US

(21) Appl. No.: 10/239,842

(22) PCT Filed: Mar. 30, 2001
(86) PCT No.: PCT/ES01/00129

(30) Foreign Application Priority Data
Mar. 31, 2000 (WO) PCT/ES00/00119

(51) Int. Cl. B65G 47/24

(52) U.S. Cl. 198/373

(57) ABSTRACT

The machine is intended for articles (A) having a different geometric configuration (A1) on one of their ends. Said machine has a linear transport device (20) for the articles (A) in lying position which has been pre-oriented in longitudinal direction with respect to said different geometric configuration (A1) that is located either in the front or back part relative to the direction of advancement of said transporting device (20). The machine also comprises a positioning station (80) of the articles (A) orienting the articles vertically and associated with the transporting device (20) and output transporting means (40) of the articles (A) that are oriented in vertical position and aligned. The machine also includes lifting means (11) to transfer the articles (A) from a bulk container (10) to a feed device (60) having first and second inclined plane (61, 62), converging in a chute space (63) on the transporting device (20). The positioning station (80) comprises a rotating element (81) provided with cavities (82) for receiving the articles (A) in a substantially radial position and with the geometric configuration (A1) in the desired position.

### FIELD OF TECHNIQUE

This invention concerns an automatic linear machine for article positioning and aligning, where these articles are of the type with a geometric configuration with one end differentiated, such as bottles with necks, in which the machine includes the means to transfer such articles from a container where they are in a disordered state to an exit conveyor where the articles are deposited in an aligned vertical position.

The machine of this invention is useful in the food, household goods, chemical and similar sectors, especially in bottling, packing, filling, labelling and similar plants.

### BACKGROUND TO THE INVENTION

The use of article positioning machines is common in the packing technique sector, especially positioning machines which put empty packages in the vertical position, with the filling neck or opening at the top.

U.S. Pat. No. 3,295,659 describes an operating principle which has become the most frequently employed of all positioning machines for articles which have a geometric configuration differentiated at one end, especially light packaging with a neck. This principle is based on allowing the article to fall under the force of gravity into a drop channel from a low, pre-orientated, longitudinal position. The mouth of this drop channel includes end-stop and supports which hold the differentiated geometric configuration no matter what the article's relative position is with respect to the longitudinal axis of the article. For this reason, at least of the end-stops forces the article to position itself at the mouth of the drop channel in a different way according to this relative position of the differentiated configuration, so that this is always above one of the support configurations. The machine adopts a rotating configuration in which a series of cavities designed to receive a pre-orientated article are arranged in a radial fashion on the periphery of a circular structure.

The previously described operating principle with its associated rotating configuration has undergone extensive evolution which has lead to the current positioning machines, such as the one described in U.S. Pat. No. 4,681,209 by the current applicant, in which a series of cavities are tangentially arranged at the periphery of a rotating plane which receives the articles in a disordered fashion. In virtue of the rotating movement and of the special machine configuration, each cavity holds a package in a horizontal, tangentially pre-orientated position, with the neck either to the front or rear with respect to the direction of rotation. Each of these cavities has an open bottom over an associated drop channel which moves with it. Between the open cavity bottoms and the respective drop channels is a stationary support plane that represents an interruption in a small section of the path and through which the article falls by gravity inside the drop channel, which forms a first section in the shape of a funnel. In determined areas of these cavities are the mentioned end-stops and supports that hold the neck when the package falls into the drop channel through the support plane interruption, so that the article is always in the vertical position inside the drop channel, with the neck uppermost. Deflectors finally transfer the position orientated articles from the drop channels to an exit conveyor.

This type of rotating machine, with various variants, has become firmly established on the market due to its efficiency and high level of productivity. However, the machine is large and both price and operating and maintenance costs are proportionally high.

Therefore, for those cases requiring medium or low production rates, or where available space is reduced, there is a potential market demand for an automatic linear machine for positioning and aligning articles such as light empty bottles or packages, and suitable for medium or low production rates, with reduced space requirements and moderate acquisition and operating costs. A linear positioning machine could fulfil these requirements.

Obeying a different operating principle, U.S. Pat. No. 4,463,846 describes an article positioning machine that is fed by a linear conveyor where the articles advance in a low fashion, longitudinally pre-orientated, with a geometric configuration with one end differentiated either to the front or rear with respect to the conveyor direction of movement. These articles are typically light, empty bottles, where the differentiated configuration is a neck. The machine has a positioning station to vertically position and align the articles on exit conveyors, where the positioning station is based on a rotating structure with respect to the horizontal axis, and which is tangentially fed at the top by the mentioned linear conveyor. Both the conveyor and the rotating structure work together with a predetermined article body conformation in order to hold it by two side points, close to an end opposite the neck, so that a horizontal axis is defined between these two points around which the article may rotate. It should be pointed out that this predetermined article body conformation has no other purpose than to co-operate with the positioning machine meaning that the articles must be suitable for use with this machine. The articles move on the support surface along the length of the linear conveyor. However, on arrival at the rotating structure, the articles are pushed by a friction wheel that rotates in the opposite direction to the structure at a slightly high speed, so that, depending on the relative position of the neck, with respect to the direction of movement, the article is either directly taken upright to a collection point, or is rotated until it makes contact with an end-stop and falls upright into the same collection point, from which exit conveyors leave.

However, in addition to being complex, this machine has the serious inconvenience of only being operational with the described predetermined article conformation, without which the system's operating principle is not valid, which constitutes a serious limitation with regards to the variety of articles or packages that may be handled. In addition to the holding and turning of the articles by these two side points may leave behind unwanted marks on the outer surfaces of the package. Moreover, this patent does not explain how the articles pass from a disordered state, in which they originally exist in a suitable container, to the referred low, longitudinally aligned arrangement on the feed conveyor.

U.S. Pat. No. 2,855,740 describes a machine for loading articles into boxes which consists of a entry linear conveyor bringing the bulk disordered articles. At the end of the entry conveyor is a rotating wheel with many transversal cavities around its periphery, in the fashion of a Ferris wheel, into which a predetermined number of articles are inserted, which are turned and deposited on the lower part of this wheel in boxed which advance in synchronism along a linear exit conveyor.

This machine however, does not carry out the positioning in accordance with a pre-selected orientation, which means that is only useful for articles that do not require positioning in any specific position, such as fruit and vegetables, especially those that have an approximately round shape, such as tomatoes, but not for positioning packages upright and aligned.

Another growing requirement, especially in the food product packaging industry, is the need to perform a rapid cleaning operation of each package when it is upside down, whether by the introduction of some cleaning fluid into the interior through the neck or by suction of the interior or even a combination of both operations consecutively.

### BRIEF DESCRIPTIONS OF THE INVENTION

One objective of this invention is to provide an automatic machine for positioning and aligning of articles, which has relatively small dimensions, together with reduced purchases and running costs and suitable for medium or small production runs.

Another objective of this invention is to provide an automatic machine for positioning and aligning of articles, especially light, empty packages and suitable for medium or small production runs and fitted with a cleaning device and/or vacuum cleaner for the interior of the articles when these are upside down.

These objectives are achieved with this invention providing an automatic machine for positioning and aligning of articles, especially articles of the type with a geometric configuration that is differentiated at one end, such as light, empty packages fitted with some from of neck, where the machine basically consists of a container for these articles in a disordered bulk condition, a linear conveyor for the articles coming from this same container in a low position, longitudinally pre-orientated, with the differentiated geometric configuration either at the front or rear with respect to the direction of travel of the conveyor and a positioning station for placing the articles in the upright position connected to an area on the linear conveyor, together with the means of taking the articles to the exit in a vertical, aligned position.

This same machine also includes a feeder for supplying the articles from the container, where they are stored in a disordered fashion. To the linear conveyor, with them being placed in the pre-orientated position and, depending on the type of used positioning station, the linear conveyor has an associated selector device to reject or turn those packages which are not in the correct orientation on the conveyor.

This feeder includes at least first and second inclined planes for receiving disordered articles coming from the container. These first and second inclined planes converge on a drop space delimited by two vertical parallel planes separated by an adjustable distance, slightly larger than the smallest transverse dimension of the articles, the drop space of which is aligned over a portion of the linear conveyor, which is typically an endless conveyor belt. According to a variant, these inclined planes work together with other walls to form a chute. According to another variant, the first inclined plane consists of a rotating inclined disk, which receives the articles coming from the container at its highest level and leads them to the mouth area of the drop space which is adjacent to its lowest level. The container may be located above this chute or rotating disk and allow the articles to fall into it by the force of gravity. However, in a preferred constructed example, the container is on a lower level with respect to the first and second inclined planes and includes the means of elevation, such as a continuous belt elevator with blades to transfer the articles from the container to the feeder. An advantage is that the container is also at a lower level with respect to the conveyor and backed on to at least one section of it at the feeder exit and where the means of elevation are located to return those articles remaining in an unwanted position, such as superimposed or one on top of another article and upright, among others.

In this way, the articles are lifted from the container by the mentioned elevator and allowed to fall in a disordered fashion onto the feeder's inclined planes, along which they slide and concentrate at the mouth of the adjustable width drop space and slowly enter it, where they are subjected to a first movement restriction. When the articles reach the bottom of the drop space, they make contact with the conveyor's moving surface and are turned until they are pulled along due to conveyor belt friction, and reveal a natural tendency to adopt a low position on their longest dimension with the differentiated geometric configuration already located to the front or rear with respect to the conveyor direction of travel. It must be taken into account that when these articles also present two differentiated transverse dimensions, and in virtue of the separation distance between the vertical parallel planes, slightly longer than the smaller of these transverse dimensions, the articles become longitudinally aligned with the conveyor supported on one of their narrow sides. Those articles which, because of accumulation, do not adopt this arrangement will be rejected and returned to the container by the described deflectors.

In the variant with a chute, it is probable that the accumulation of articles at the mouth of the drop space will lead to a blockage, for example, due to a mutual joining of protuberant parts on the articles. In order to provide a solution to this problem, one or more of the feeder planes are connected to a shaker, such as a fluid dynamic cylinder, controlled by some means of detection, preferably an optical sensor, which is located so as to cover the mouth zone. When these sensors detect an excessive accumulation of articles A in this zone, a command is issued for the shaker to provide a brief shaking or vibration to these planes which is sufficient to break up the blockage.

In the variant fitted with the rotating disk, a heavy accumulation of disordered articles occurs, which are removed by the rotating disk itself, which guarantees that a high proportion of them enter the drop space, where they are returned incorrectly positioned on the conveyor back to the container by deflectors.

The pre-orientated articles are taken by the linear conveyor to the positioning station, of which there are two versions. In the first version, the positioning station always orientates the articles in a vertical position, with the differentiated geometric configuration in a predetermined position (for example, upright package with the neck to the top) no matter what the position of the differentiated geometric configuration of the pre-orientated packages fed by the linear conveyor. In the second version, the positioning station will only place in a vertical position, those packages which have been previously orientated with the differentiated configuration in the desired position. In order to achieve this, before arriving at the positioning station, the entry conveyors include a selector device that rejects or turns those packages advancing with an unwanted differentiated geometric configuration.

In accordance with the first version, the positioning station consists of an end-stop in the article's path that comes into action to halt this articles advance at a specific conveyor area. This end stop is such that the article is detained with the differentiated geometric configuration beyond a reference line when it advances with this configuration to the front or the opposite end of the article to this configuration at the reference line when advancing with this same configuration to the rear.

At this positioning station, there is a displacing device which drags the article sideways, which is detained by the end-stop, from the conveyor zone to at least an open space over a drop channel adjacent to the conveyor. In a preferred constructed example, two such drop channels are located adjacent to both sides of the linear conveyor zone, below the two open spaces, with the displacing device operating to alternatively distribute articles towards one then the other open spaces. On at least some of the edges of these open spaces are the means of support for the differentiated geometric configuration of the article during its fall inside the described drop channel, whatever the position of the configuration with respect to the direction of travel of the articles.

This support for the differentiated configuration of the articles over the open spaces is always performed in accordance with the relative article position with respect to the described reference line. Thus, these means of support consist of a front support element located in front of the open space with respect to the conveyor advance, immediately in front of the reference line, together with a rear support element located to the rear of this same open space, where the separation distance of the front support element is slightly longer than a longitudinal dimension of the article “body”, where this body length is its total length less the length of the differentiated configuration. For example, if the article is a bottle with neck, the “body” length is considered as being the total length, but without including the neck length. With this arrangement, when the article is moved over one of the described open spaces, it is always supported by its differentiated configuration, so that its fall begins with the opposite end, which is never supported independently of the article orientation with regards to the conveyor direction of travel.

The described displacing device consists of at least one longitudinal vertical wall with appreciable thickness, either solid or hollow, connected to alternate sideways means of operation, such as a fluid dynamic cylinder, the wall of which is at least as thick as the separations between the conveyor and each of the open spaces. Preferably, the displacing device will have two sideways moving compartments, with at least the entrances and bottoms open, with the described longitudinal wall being a dividing wall for these compartments. With this configuration, in one of the alternate displacing device positions, one of the compartments is aligned over this linear conveyor zone and the other is over one of the open spaces of one of the sides, while, in the opposite alternate position, the compartment which was over the described open space is located over the conveyor zone and the other compartment now occupies a position over the open space on the opposite side, and so on, with each alternate position permitting an article to penetrate the compartment over the conveyor zone and that another article drops through one or other of the open spaces over the drop channel, with the article falling inside the described channel and being initially supported by one of the front or rear support elements, making contact with the article's differentiated geometric configuration, so that it rotates in order to drop on the end opposite this configuration. This operation will be described in more detail later in relation to the attached drawings.

It must be noted that the end-stop and/or front support element may be associated with the described displacing device compartments, moving with them, or they can be stationary extending in a continuous fashion over the front part of the linear conveyor zone in the orientation zone. The end result in both cases is identical.

In order to adapt the machine of this invention to the various types of articles, having different dimensions, various positioning station elements, the feeder and the means of exit transfer include the means of regulation and adjustment. One example of the means of regulation consists of having the an upper section of the drop channel in the form of a funnel, where one part is made up of two partially overlapping halves capable of being fixed in at least two, mutually relative, different positions. In an automatic version, these two halves are connected to a displacing device, such as a fluid dynamic cylinder, suitable controlled by centralised means of control. Other adjustable elements may be operated in a similar fashion.

This positioning station also includes the means to transfer the articles from the described positioning station drop channels to the exit conveyors orientated and aligned in a vertical position, where the means of transfer in a preferred construction example consist of an article displacing device in an alternate transverse direction from each of the described drop channels to a reception area for the exit conveyors, with the described reception area located between both drop channels. This displacing device includes two suitable adjacent compartments, with upper, lower and sides open, each capable of being alternately located below a corresponding drop channel, forming the lower part over the described reception area of the exit conveyor. Below the upper part in form of a funnel and on a level with the conveyor, are some fixed support planes. The adjacent positioning station may be constructed in a similar manner to the displacing device compartments described above and may be connected to similar means of operation synchronised with the positioning station by means of the described central control. Advantageously, the exit conveyor consists of a perforated continuous belt associated with a vacuum chamber located below, at least in the reception area, in order to apply a suction force to the article support base, pulling it to the continuous belt in order to assist traction and stabilise the exit path at least in the initial section.

However, these described means of transfer may adopt other forms, such as two perforated belts fitted with a suction chamber, each commencing its path from below respective lower fixed parts, with an open forward side of the drop channels, where the two belts later join in a single conveyor, or rotating device joined to several compartments capable of acting as lower areas of the drop channels, with deflectors associated with the described rotating device in order to transfer the articles to the exit conveyor belts.

In accordance with the previously described second variant, the positioning station requires a prior, predetermined orientation of the articles on the conveyor belt because the positioning station places them upright in a single direction. For this reason, a selector device associated with the entry linear conveyor is included, which consists of the means of detection, preferably electronic such as optical sensors or video cameras, which detect the differentiated geometric configuration of the articles with respect to their direction of travel. When it is detected that an article does not have the differentiated geometric configuration in the required position, the sensors send a command to a ejector device, such as a pusher driven by a fluid dynamic cylinder, which ejects the detected article from the conveyor and it is returned to the adjacent initial container, or it sends an command to a turning device which rotates the article through 180° on the conveyor leaving it with the differentiated geometric configuration in the required position. Both devices are equally effective, however, the first is simpler and more economic, whereas the second is more productive and the choice of one or the other system is based according to required productivity and available economic means.

With the inclusion of the above-described selectors, all the articles reach the positioning station with the differentiated geometric configuration in the predetermined position, so that operation of this positioning station is limited to placing them upright from this position. A simple example of this consists of having at the end of the entry linear conveyor, at least one open space over at least one drop channel fitted with an open bottom and through which the articles fall and are located in a vertical position on the exit conveyor. Such a drop channel is a simplified version of the drop channels in the first positioning station variant.

A more significant example of the second variant of positioning station consists of a rotating element fitted with suitable cavities for receiving an article with differentiated geometric configuration in the required position, where the rotating element is located at the end of the entry linear conveyor and which rotates at a speed suitable for the feed frequency, so that the articles enter the described cavities as they reach the end of the conveyor. As it turns the rotating element deposits the articles in the vertical position on the exit conveyor.

Preferably, the machine in this invention includes, at the entry conveyor and positioning station entry, mobile retaining device, such as a fluid dynamic cylinder shaft, which momentarily retains each article, while the rotating element turns in order to carry the previous article and to situate another empty cavity in front of the momentarily retained article.

On certain occasions, depending on the type of production or the characteristics of the article being handled, it is required that the positioning station deposits the articles inside individual support elements, in the form of pucks, which can then be later manipulated individually. In order to accomplish this, the machine in this invention includes a delivery device, which sequentially positions these individual article support elements on the exit conveyors, right in the area where the rotating element deposits the articles in a vertical position through the force of gravity, so that each article is deposited inside one of the individual support elements, which is then transferred by the exit conveyor.

The described delivery device for the individual support elements and the described rotating element are synchronically driven, typically by a common motor connected by means of various transmissions, in order to guarantee the correct position of the individual support elements under the rotating element to receive the articles. However, it is important that no individual empty support element leaves the exit conveyor because, for whatever reason, an article has not entered a given cavity of the rotating element. To ensure this, a means of detection is included, such as an optical sensor, which detects the presence of an article in the cavity which is in the filling position, with the rotating element and the individual support element delivery device only being operated when the presence of an article in the relevant cavity is detected.

Especially when the articles are light empty packages intended to be fed to a filling station, it is usual, and in some jurisdictions compulsory, to carry out a cleaning operation of the inside of the packages prior to filling. In order to achieve this, the packages enter the cavities with the neck in the forward position and then the rotating element turns in a direction so that the same articles pass through a raised area in the inverted vertical position, in other words, with the neck downwards, before being rotated once again and deposited upright on the exit conveyor. The short time during which the packages are upside down is used to carry out the interior cleaning operation. For this reason, each of the cavities has at least one interior cylindrical wall which is coaxial with the rotating element axis, where the package neck is supported on the cylindrical wall. This wall is fitted with at least one aperture that is aligned with the necks. During the rotating element rotation, the packages pass upside down through the described raised area where the necks match up with a blower nozzle containing cleaning fluid or a suction nozzle through this aperture, or both consecutively, with the rotation then continuing until they are deposited upright on the exit conveyor.

### BRIEF DESCRIPTION OF THE DRAWINGS

This invention will be better understood by means of the following detailed description of some preferred construction examples, where the description contains references to the included drawings, in which:

FIG. 1 is a simplified general view, in perspective, of the automatic linear machine for orientating and aligning in accordance with a first example of construction of this invention;

FIG. 2 is an enlargement showing a variant in the construction of part of the machine shown in FIG. 1;

FIGS. 3 and 4 are partial side elevation views, which illustrate the operating principle for setting the articles upright in the machine in FIG. 1;

FIG. 5 is an enlargement of the positioning station of the machine in FIG. 1 in a first alternate position and with a possible situation of the articles inside;

FIG. 6 is the same enlargement as FIG. 5 in a second alternate position and with another possible situation of the articles inside.

FIG. 7 is a simplified general view, in perspective, of the automatic linear machine for orientating and aligning in accordance with a second example of construction of this invention;

FIG. 8 is a side view of the linear conveyor of FIGS. 1 and 7 showing the arrangement of the pre-orientated articles on it;

FIG. 9 is an enlargement of a turning device in a variant of the means of selection of the machine in FIG. 7;

FIG. 10 is a side section of the rotating element of the machine in FIG. 7;

FIG. 11 is a diagrammatic view in elevation which illustrates the operation of the positioning station for the machine in FIG. 7;

FIG. 12 is a simplified general view, in perspective, from an inverted angle, of the machine shown in FIG. 7, to which an individual support element positioning device has been added for the articles that are placed upright on the exit conveyor; and

FIG. 13 is a simplified general view, in perspective, of the automatic linear machine for orientating and aligning in accordance with a variant of the second example of construction of this invention.

### DETAILED DESCRIPTION OF SOME PREFERRED CONSTRUCTION EXAMPLES

The figure make use of numeric references that are the same for those equivalent parts in the various construction examples and variants.

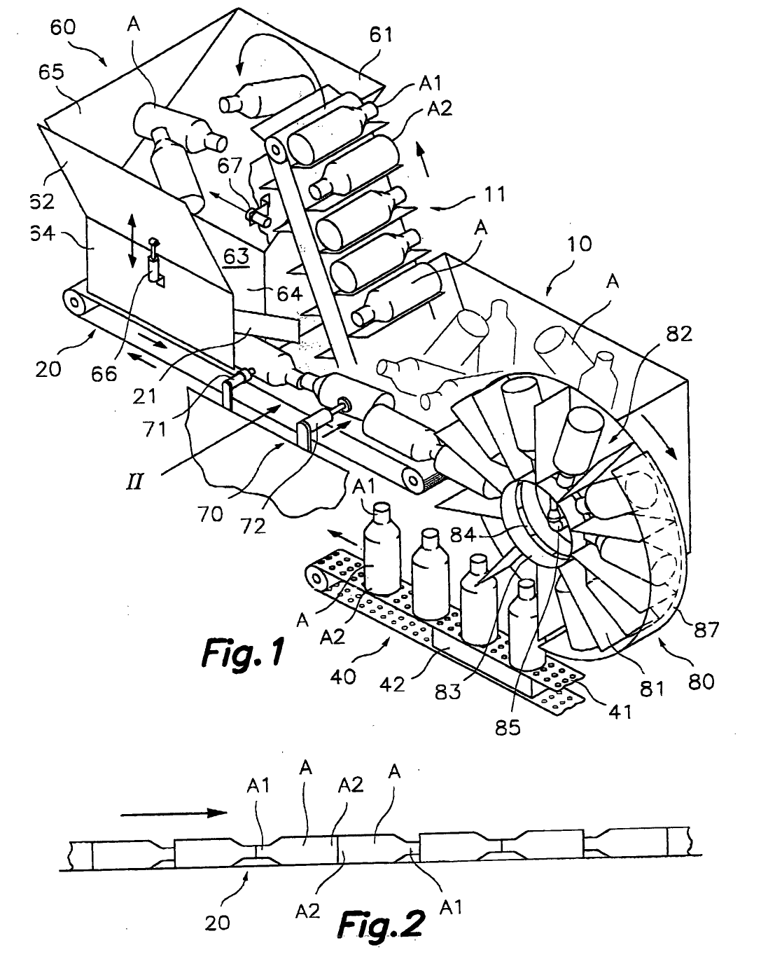

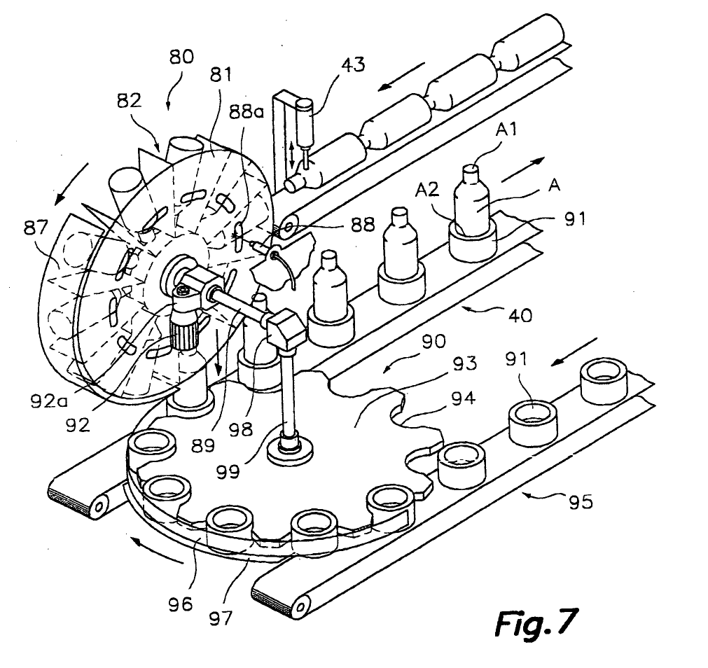

First referring to FIGS. 1 and 7, the automatic linear machine for orientating and aligning of this invention is intended for articles A of the type where is a differentiated geometric configuration A1 at one of the ends, such as bottles with necks.

The machine essentially consists of a container 10 for such articles A arranged in a disordered bulk manner; a linear conveyor 20 for articles A coming from container 10 in a low arrangement, pre-orientated in a longitudinal direction, with the described differentiated geometric configuration A1 already located either at the front or the rear, with respect to the direction of travel of this conveyor 20; a positioning station 30, 80 connected to the conveyor 20 in order to place articles A in a vertical position; together with some means of exit conveyor 40 for articles A orientated in this vertical, aligned position. The construction examples of FIGS. 1 and 7 differ only in the positioning stations 30, 80 and the associated elements.

In both construction examples, between the container 10 and linear conveyor 20, there is also a feeder 60 for feeding articles A from the described container 10 to the linear conveyor 20, depositing them on the conveyor in the described pre-orientated position. This feeder 60 consists of at least first and second inclined planes 61, 62 for receiving disordered articles A from container 10, where the first and second inclined planes 61, 62 converge on a drop space 63, which is delimited by two parallel vertical planes 64 having adjustable width by means that are not illustrated. Other walls 65 collaborate with the described first and second inclined planes 61, 62 in order to delimit a chute. The separation distance between the described vertical planes 64 is lightly longer than the smallest transversal dimension of articles A (in case, not illustrated, of having two different transversal dimensions), so that the articles can only be entered by gravity in the drop space rotated by the described smaller transverse dimension. Drop space 63 is arranged aligned over a portion of the described linear conveyor 20, which typically consists of a continuous belt so that the articles, on dropping, make contact with the conveyor and are moved along with a probable tendency to turn in an initial phase until they are in the described pre-orientated low position in the longitudinal direction, with the differentiated geometric configuration A1 located either top the front or rear with respect to the direction of travel of the described conveyor 20, and in the case of having a smaller transversal dimension, supported on one side of it. Although not shown on the drawing for improved clarity, linear conveyor 20 is fitted with bars to maintain articles A in this arrangement.

It is probable that an accumulation of articles A at the mouth of the described drop space 63 leads to a blockage, for example due a mutual joining up of protuberant parts of articles A. These blockages are difficult to avoid, but the machine in this invention solves the problem by connecting one or more planes 61, 62, 64 of feeder 60 to a shaker 66, such as a fluid dynamic cylinder controlled by means of detection 67, preferably consisting of an optical sensor, located so that it covers the described mouth area of drop space 63. When these sensors 67 detect an excessive accumulation of articles A in this area, they will send a command via a control centre for shaker 66 to apply a brief shake or vibration to planes 61, 62, 64, which is sufficient to remove the blockage.

Container 10 is on a lower level with respect to the described first and second inclined planes 61, 62 and consist of conventional elevators 11, which transfer articles A from container 10 to feeder 60. Container 10 is also preferably on a lower level with respect to conveyor 20, of which at least one section is backed on to the exit of conveyor 60, where there are the means of deflection 21 to return those articles A which remain in an unwanted position, such as superimposed or one on top of another article and upright, among others.

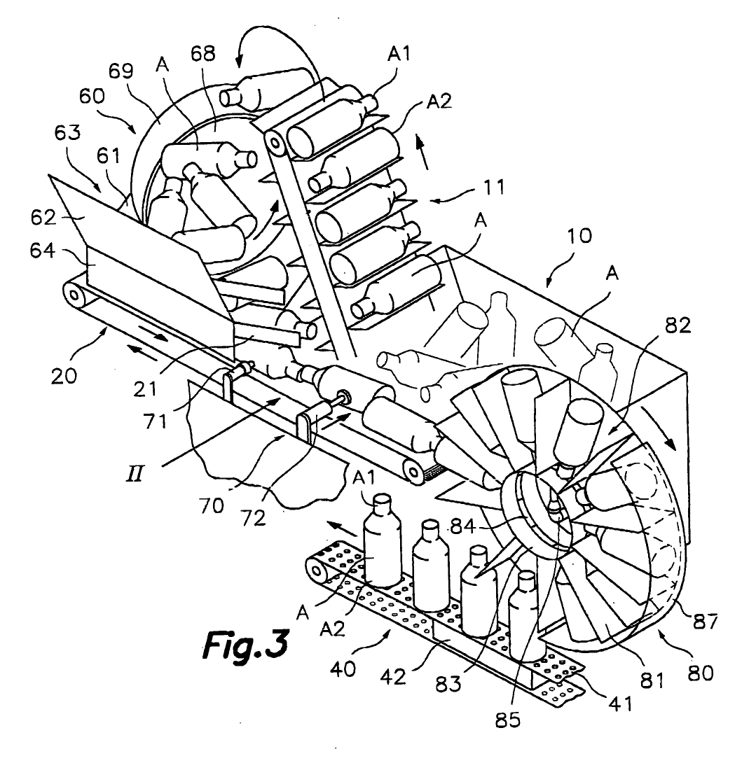

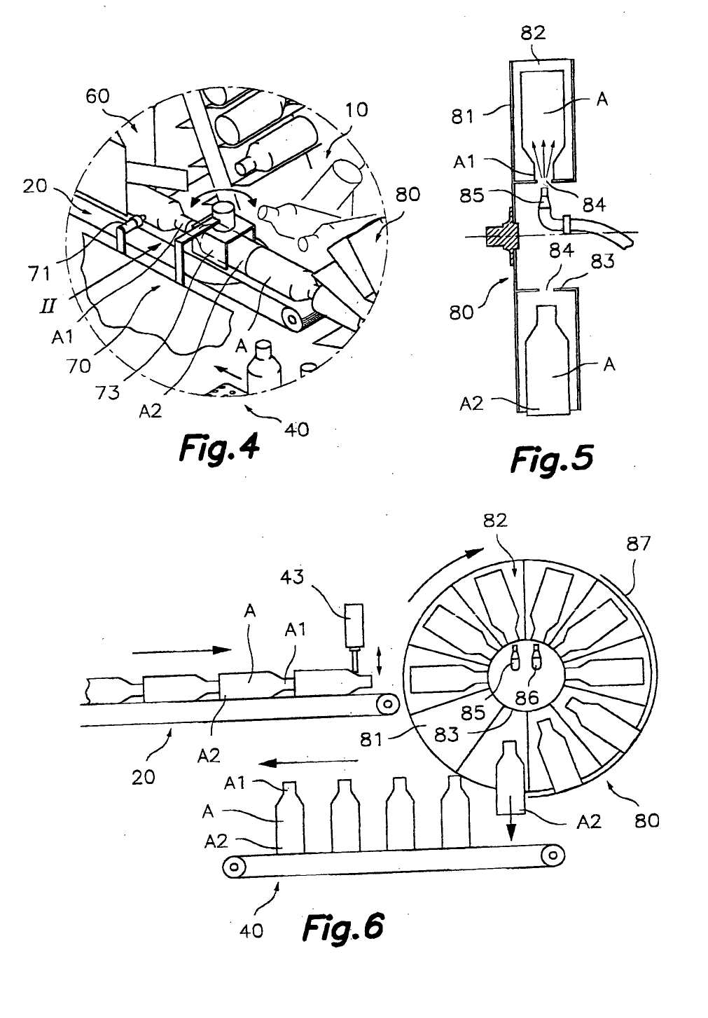

Specifically referring nor to FIG. 1, in an area of conveyor 20, preferably at the end, is the described positioning station 30, which consists of end-stops 34a, 34b located in the path of conveyor 20 to detain the advance of an article A in an area Z of the conveyor. Just as shown in FIGS. 3 and 4, the construction of end-stops 34a, 34b is such that, when an article A enters the described area Z advancing with differentiated configuration A1 to the front, in accordance with the direction of travel of the conveyor (FIG. 3), end-stop 34a detains the article with its differentiated geometric configuration A1 in front of a reference line R. On the other hand, when an article A enters the described area Z advancing with differentiated configuration A1 to the rear (FIG. 4), then the end-stop 34b detains article A in area Z of conveyor 20 with the opposite end A2 of article A at reference line R. There is a displacing device 31 located at area Z, which is connected to alternate sideways drives 38, such as a fluid dynamics cylinder, where the displacing device 31 alternately transfers articles A in a transversal direction from area Z of conveyor 20 to at least one open space, although preferable, as illustrated by the example in FIGS. 1, 5 and 6, two open spaces 32 over the two drop channels 33 located on either side of conveyor 20, which is adjacent to area Z.

In relation to FIGS. 5 and 6, at the edges of open space 32 are located the means of support for the differentiated geometric configuration A1 during the drop of article A inside the drop channel 33 in accordance with the described position relative to reference line R. The described means of support consist of a front support element 35 and a rear support element 36 with respect to the direction of advance of conveyor 20. At least when article A is above the open space 32, the described front support element 35 is located between the end-stops 34a and 34b, immediately in front of reference line R, while the rear support element 36 is located at a distance from the front support element 35 in function of a longitudinal dimension of the body of article A. As has been previously explained, “length of body” is understood as being the total article length less the length of its differentiated configuration. In the illustrated example of a bottle with neck, the “length of body” of the bottle is considered as being the total length of the body, but without counting the length of the neck. As can be seen in FIGS. 3 and 4, this is the length existing between the front 35 and rear 36 support elements located over the open space 32. With this arrangement, no matter what the neck position with respect to the direction of travel of the bottle on conveyor 20 (indicated by the arrows on FIGS. 3 and 4), the neck A1 will be supported either by the front support element 35 or the rear support element 36 over the open space 32, whereas opposite part A2, or base of the bottle A will never be supported, so that bottle A will initiate its drop by this base A2 inside drop channel 33 in the form of a funnel, causing the bottle to always drop upright. Obviously, this operating principle will be equally applicable to articles other than bottles.

In a variant illustrated in FIG. 1, end-stops 34a and 34b and the front support element 35 consist of a single part in the form of a “Z” profile and are stationary, extending in a continuous manner over the front sections of both open spaces 32 and over the front section of area Z of linear conveyor 20, so that when articles A are transferred to area Z, one of the open spaces slides with its differentiated geometric configuration A1 supported along the length of end-stop 34a or 34b and front support element 35 or with its opposite end A2 supported along the length of end-stop 34b. On the other hand, in the variant illustrated in FIGS. 5 and 6, end-stops 34a, 34b and the front support element 35 are associated with displacing device 31, and move with it. Both variants, together with their combinations are equally effective.

Although in the variants of FIG. 1 and FIGS. 5 and 6 the end-stops 34a and 34b, together with front support element 35 are integrated into a single part, they could be made up of various pieces and adopt various shapes.

Displacing device 31 consists of a vertical longitudinal wall 37, either solid or hollow, having a width that is at least equal to the separations between the conveyor 20 and each of the open spaces 32. In an example of preferred construction, this vertical longitudinal wall 37 is joined to other walls that make up two compartments 37a, 37b, one on each side of wall 37, which are able to move sideways and with at least their entries and lower sides open.

FIGS. 5 and 6 show the operation of positioning station 30 respectively with a first and second alternate positions and with the two possible situations of article A in area Z.

FIG. 5 corresponds to the same situation of the positioning station 30 as illustrated in FIG. 1, and shows an article A in area Z of conveyor 20 inside a compartment 37a, with differentiated geometric configuration A1 to the front with respect to the direction of travel of conveyor 20. This differentiated geometric configuration A1 is situated over the described front support element 35 beyond reference line R, being retained by end-stop 34a. In the other adjacent compartment 37b, over open space 32 of drop channel 33, is the other preceding article A, which had entered the positioning station 30 with the differentiated geometric configuration A1 to the rear and the opposite end A2 to the front and detained by the configuration of end-stop 34b at reference line R. The described other article A had previously been transferred by displacing device 31 to one of the open spaces 32 where it commenced a drop inside the corresponding drop channel 33 with the differentiated geometric configuration A1 temporarily supported by the rear support element 36 and the opposite end A2 free from support by the front support element 35.

FIG. 6 shows a situation immediately after that of FIG. 5, in which article A that was inside compartment 37a in area Z in the situation of FIG. 5 has been later moved sideways by displacing device 31 to the other of the open spaces 32 located on the opposite side, where it commences a drop inside the corresponding drop channel 33 with the differentiated geometric configuration A1 temporarily supported by the front support element 35 and the opposite end A2 out of range of rear support element 36. Simultaneously, the now empty other compartment 37b is located over the described area Z and has been immediately occupied by the following article A, which on this occasion presents opposite end A2 to the front and is detained at reference line R by the configuration of end-stop 34b.

It is important for the transverse translation speed of displacing device 31 to be sufficient with respect to the advance of conveyor 20 to allow a compartment 37a, 37b to be fully located over area Z before the arrival there of the following article A.

In another execution variant, the machine incorporates the means to adjust positioning station 30 to various types of article A with different dimensions. In FIG. 2 is shown an example of such means of adjustment which consist of an upper section of the drop channel 33, in the form of a funnel, consisting of two halves 33a, 33b partially overlapping, sliding, able to be fixed in at least two, mutually relative, different positions. In this example, each half 33a and 33b of drop channel 33 incorporates respectively, the rear support element 36 and end-stop configurations 34a, 34b with the front support element 35. In an automatic version, these two halves 33a, 33b are connected to a displacing device 39, such as a fluid dynamic cylinder, suitably controlled by a centralised means of control. Other means of regulation may be similarly adjusted by similar methods.

Returning to FIG. 1, the machine of this construction example also includes the transfer device 50 for articles A from the same drop channels 33 on the positioning station 30 to the exit conveyor 40 for articles A orientated in a vertical, aligned position. This transfer device 50 consists of a displacing device 51 connected to a drive 53 to transfer the articles A in an alternate transverse direction from each of the drop channels 33 to a reception area of the exit conveyor 40, where the reception area is located between the two drop channels 33. In a similar fashion to displacing device 31 of positioning station 30, this displacing device 51 consist of two adjacent compartments 51a, with its upper, lower and front sides open, each capable of being alternately located below a corresponding drop channel 33, forming a lower part of the same, and over the reception area of exit conveyor 40. Adjacent to both sides of the reception area are fixed support planes 52 for articles A. The exit conveyor 40 consists of a perforated continuous belt 41 associated with a vacuum chamber 42 located below the same belt 41, at least in the reception area, in order to apply a suction force to the article A support base, pulling it to the continuous belt 41 in order to assist traction and stabilisation at least in the initial section of the exit path.

Referring now to FIGS. 7 to 12, these show a machine of the invention which incorporates a second construction example for positioning station 80 for articles in the vertical position, where the machine, in the same way as that of FIG. 1, consists of container 10 for articles A disordered in bulk; a feeder 60 for linear conveyor 20 of articles A coming from this same container, in a low arrangement, pre-orientated in the longitudinal direction, with this differentiated geometric configuration A1 already located either to the front or rear with respect to the direction of travel of conveyor 20, with the description of such devices being the same as that provided above in relation to FIG. 1. This also includes positioning station 80 for articles A in a vertical orientation, together with exit conveyor 40 for articles A orientated and aligned in the vertical position.

FIG. 8 shows the articles arrangement on conveyor 20 just as they are fed by feeder 60, in other words, with differentiated geometric configuration randomly located to the front or rear with respect to the direction of travel of conveyor 20, as indicated by an arrow.

In this case, because of the special operating principle of positioning station 80, which is described later, the described linear conveyor 20 is associated with selector 70, which is located before positioning station 80, to remove from the conveyor or to rotate through 180°, those articles A which are advancing with the described differentiated geometric configuration A1 located, either front or rear, in an unwanted position, so that the articles A are always fed to the positioning station 80 with the differentiated geometric configuration A1 always in the required position with respect to the direction of travel. When articles A are light empty packages and the differentiated geometric configuration is their neck, just as illustrated in the figures, it is necessary for this neck is located to the front of the package with respect to the direction of travel of the conveyor 20 so that positioning station 80 can set them in the vertical position on their base A2, with neck A1 upright.

The described selector 70 consists of detector 71, such as an electronic reader, optical sensors, video camera or similar, to detect the position of differentiated geometric configuration A1 in articles A which advance along conveyor 20. When detector 71 detects an article A with the differentiated geometric configuration A1 in an unwanted position, in the illustrated example it is a package with the neck to the rear with respect to the direction of travel, it will issue a command to an ejection device 72, such as a pusher driven by a fluid dynamic cylinder, to push this detected article A off the conveyor 20, preferably into container 10 again.

Alternatively, as shown in FIG. 9, instead of ejection device 72, selectors 70 of the machine in this invention may incorporate a turning device 73 to turn this detected article A through 180° on conveyor 20. The turning device 73 is known and consist of a tubular passage without a base wall through which articles A pass arranged on conveyor 20. In response to a signal from the detector, a fluid dynamic actuator very quickly rotates this passage through 180° along an axis normal to the conveyor surface, so that article A is able to continue its advance, but now with the required pre-orientation. Preferably, the device will include a detent (not shown), driven by a fluid dynamic cylinder, which momentarily detains the article following the one being turned in order to prevent any interference with turning device 73. In this way, all the articles arrive at the positioning station pre-orientated in the required fashion, which in the illustrated case are bottles A with neck A1 to the front of the packages, just as can be seen better in FIG. 11.

One very simple construction example, not shown, for positioning station 80 consists of the means to take the articles A to at least one open space over at least one drop channel in the form of a funnel fitted with an open bottom through which articles A are located in the vertical position over the exit conveyor 40. This drop channel is similar to those described in relation to the construction example of FIGS. 1 to 4 in a simplified version.

However, in a more complex construction example, just as shown in FIGS. 7 to 12, positioning station 80 consists of a rotating element 81 fitted with cavities 82, each of which is suitable for reception of an article A with the geometric configuration A1 in the desired position, where rotating element 81 turns at a speed that is adequate for the feed frequency of linear conveyor 20, and which, as it rotates, deposits articles A in the vertical position on this exit conveyor 40. In order to prevent that articles A from exiting the cavities 82 on the rotating element 81 during its descent path, this part is fitted with stationary surrounding wall 87, against which the articles A are supported and slide to an interruption of this same wall 87, through which articles A drop upright, supported on their bases A2, onto the exit conveyor 40, which may be, for example, a perforated conveyor belt through which a depression is applied (as shown in FIG. 7), or each article A is deposited upright in side one of the pucks 91 located on the exit conveyor 40 at suitable intervals.

FIG. 12 shows a delivery device 90 for sequentially locating one of these pucks 91 for articles on the exit conveyor 40, just in the area where the rotating element 81 on turning, deposits an article A by gravity in the vertical position, so that each of these articles A is deposited inside one of these pucks 91, which is then taken away by exit conveyor 40 before the delivery device deposits another puck 91 under rotating element 81. The described delivery device 90 consists of a rotating disc 93 fitted with a series of recesses 94 at regular intervals at its perimeter, with disc 93 being located tangentially on one side a puck 91 conveyor 95 and tangentially on the other side the exit conveyor 40. The pucks 91 advance on the conveyor 95 and arrive at the perimeter of disc 93 at a suitable speed, so that each puck 91 is coupled by on of the recesses 94 of the disc 93, which takes it along a curved path, with the aid of a deflector wall 96, over a support plane 97, until it is deposited on the exit conveyor 40 in the described position under the rotating element 81, where it receives the upright article A and continues along its path, together with article A on conveyor 40.

It is evident that this puck 91 delivery device 90 and the rotating element 81 are synchronously driven in order to guarantee the correct puck 91 position where the upright article A is deposited. Typically, this synchronism is achieved just as shown in FIG. 12, by means of drive from common motor 92 connected via gearing 92a to rotating shaft 89 of rotating element 81, where shaft 89 is connected via a kneed retransmission 98 to rotating shaft 93a of disc 93, which thus ensures correct positioning of the pucks 91 under rotating element 81 for receiving articles A.

It is also important that no empty puck 91 leaves the exit conveyor 40 because, for whatever reason, an article A has not entered a given cavity 82 of the rotating element. To ensure that this possibility does not occur, a means of detection is included, such as an optical sensor 88, which detects the presence of an article A in the cavity 82 which is in the filling position, in other words to detect when an article A has in fact entered cavity 82. In order to facilitate this detection, each cavity 82 has a small window 88a, in a side wall of the rotating element 81, so that these windows 88a are successively placed in front of optical detector 88 when the corresponding cavity 82 is in the position to be filled with an article A. The drive to the described rotating element 81 and the puck 91 delivery device 90 only operates when an article A is detected in the corresponding cavity 82.

Another important feature of the machine in this invention is the possibility of cleaning articles A during the operation to put them upright, especially when the articles A are empty bottles or packages intended for a filling line with products for human consumption. Rotating element 81 turns in a direction such that articles A pass through an inverted vertical position (FIG. 10) before being deposited on exit conveyor 40. This inverted position may be used to advantage for carrying out a brief cleaning operation for the interior of articles A by means of blowing or suction, since the force of gravity will assist in the elimination of solid particles inside the packages. For this reason, cavities 82 have at least one cylindrical wall 83, which is coaxial with the rotating shaft on rotating element 81 that defines an empty space in the tub of rotating element 81. Neck A1 of packages A is supported on this cylindrical wall 83, with this same wall 83 having at least one aperture 84 aligned with the apertures of necks A1. There is a cleaning fluid blower nozzle 85 or suction nozzle 86 inside the empty tub of the rotating element 81, or both arranged consecutively along the path of this aperture 84 in the cylindrical wall 83 so that, just as shown in FIGS. 10 and 11, the apertures of necks A2 of packages A are facing these nozzles 85, 86 via aperture 84. This described cleaning operation is continuously carried out, without detaining rotating element 81.

FIG. 13 shows a variant of the second construction example which only differs from the example of FIG. 7 with respect to the feeder 60, which also in this case, consists of a first and second inclined planes 61, 62 which converge to receive articles A from container 10 and take them to the mouth area of a drop space 63 delimited by two vertical parallel planes 64. However, the first inclined plane 61 consists of an inclined rotating disc 68, which receives the articles A from container 10 at its highest level and takes them to the mouth area of the drop space 63 which is adjacent at its lowest level. The first inclined plane 61 may have a lower slope than the first inclined plane 61 of the variant in FIGS. 1 and 7, which does not have the described inclined rotating disc 68. This rotating disc 68 may be completely flat or may have a progressive elevation towards the centre, forming an approximate conical surface, at least at the centre, and preferably its perimeter edge is substantially level with the first inclined plane 61. A fixed side wall 69, delimits a space around the rotating disc 68. Because of the inclination of plane 61, and the effect of the rotating disc 68, a large disordered accumulation of packages A occurs at the upper mouth area of the drop space 63, which are moved by the rotating disc 68 in a way that guarantees a high proportion of them enter the drop space 63, at the bottom of which here is also located linear conveyor 20 which takes them on the positioning station 80. A series of deflectors 21 return all those packages A to container which, although they are being moved along the linear conveyor 20, they are not in the low, pre-orientated longitudinal position, with differentiated geometric configuration A1 either to the front or rear with respect to the direction of travel of conveyor 20. With this arrangement, it is practically guaranteed that there are no empty spaces between adjacent packages A, which are finally taken by conveyor 20 as shown in FIG. 8.

It is evident that any of the execution variants of feeder 60, in other words, whether according to FIGS. 1 and 7 or according to FIG. 13, is compatible with any of the various executions of positioning station 30, 80 (FIGS. 5-6 and 11, respectively) and with any of the exit conveyors 40, 90 (FIGS. 1, 7, 11, 13 and 12, respectively).

An expert in the material would be able to manufacture the machine from the previous detailed description of some construction examples, and modifications and variations will occur to him without leaving the scope of the invention, which is defined in the attached claims.

1. An automatic linear machine for article positioning and aligning, where these articles (A) are of the type with a differentiated geometric configuration (A1) at one end, such as bottles with necks, in which the machine consists of:
a container (10) for these articles (A) disorderly arranged in bulk;
a linear conveyor (20) for these articles (A) coming from this same container in a low position, pre-orientated in a longitudinal direction, with this differentiated geometric configuration (A1) located either to the front or rear with respect to the direction of travel of conveyor (20);
a positioning station (30, 80) for these articles (A) in a vertical orientation associated with conveyor (20);
an exit conveyor (40) for these articles (A) orientated in a vertical, aligned position,
characterised because it consists of a feeder (60) to feed articles (A) from this container (10) to the described linear conveyor (20) in this same pre-orientated position, where feeder (60) consists of at least a first and second inclined planes (61, 62) to receive articles (A) in a disordered manner, coming from container (10), where the first and second inclined planes (61, 62) converge in a drop space (63) delimited by two vertical parallel planes (64) separated by a distance that is slightly longer than the smallest transverse dimension of articles (A), where the drop space (63) is arranged aligned over a portion of the linear conveyor (20).

2. Machine, in accordance with claim 1, characterised because this feeder (60) also consists of other walls (65) which, together with the first and second inclined planes (61, 62) delimit a chute.

3. Machine, in accordance with claim 2, characterised because one or more of these planes (61, 62, 64) of feeder (60) are connected to a shaker (66), such as a fluid dynamic cylinder, controlled means of detection (67), such as an optical sensor, accumulations of articles (A) at the mouth of this drop space (63).

4. Machine, in accordance with claim 1, characterised because this first inclined plane (61) consists of an inclined rotating disc (68) which receives articles (A) from container (10) at its highest level and takes them to the mouth area of this drop space (63), which is adjacent at its lowest level, and a fixed side wall (69), arranged around part of the rotating disc (68) edge in order to delimit a space over itself.

5. Machine, in accordance with claims 2, 3 or 4, characterised because this container (10) is at a lower level with respect to these first and second inclined planes (61, 62) and consist of elevators (11) for transferring articles (A) from container (10) to this feeder (60).

6. Machine, in accordance with claim 5, characterised because this container (10) is at a lower level with respect to conveyor (20) and backed onto at least one section of the same at the feeder (60) exit, in which deflectors (21) are arranged to return to container (10) those articles (A) that are not on the conveyor (20) in a low position, pre-orientated in a longitudinal direction, with the described differentiated geometric configuration (A1) located at either the front or rear with respect to the direction of travel.

7. An automatic linear machine for article positioning and aligning, where these articles (A) are of the type with a differentiated geometric configuration (A1) at one of its ends, such as bottles with necks, where the machine consists of:
a container (10) of these articles (A) in a disordered bulk manner;
a linear conveyor (20) for these articles (A) coming from this same container in a low position, pre-orientated in a longitudinal direction, with this differentiated geometric configuration (A1) located either to the front or rear with respect to the direction of travel of conveyor (20);
a positioning station (30) for these articles (A) in a vertical orientation associated with conveyor (20);
an exit conveyor (40) for these articles (A) orientated in a vertical, aligned position,
characterised because this positioning station (30) consists of:
an end-stop (34a) located in the path of conveyor (20) to detain the advance of an article (A) in an area (Z) of the same with the described differentiated geometric configuration (A1) of article (A) in front of a reference line (R) when this configuration (A1) is at the front of the advance, and an end-stop (34b) located in the path of this conveyor (20) to detain the advance of an article (A) in an area (Z) of the same with the opposite end (A2) of article (A) at this reference line (R) when this opposite end (A2) es is at the front of the advance;
a displacing element (31) for articles (A) in a transversal direction from this area (Z) of conveyor (20) to at least one open space (32) over at least one drop channel (33); and
some means of support located on at least some of the edges of this open space (32) in order to support this differentiated geometric configuration (A1) during the drop of article (A) into this same drop channel (33) according to the position of this configuration (A1) of article (A) with respect to the direction of travel.

8. Machine, in accordance with claim 7, characterised because these means of support consist of a front support element (35) located, at least when article (A) is over the open space (32), at the front part of this open space (32) with respect to the conveyor (20) direction of travel, immediately in front of this reference line (R), together with a rear support element (36) located at the rear of this open space (32), with the free distance between these front and rear support elements (35, 36) slightly larger than the length of article (A) without including the differentiated configuration (A1).

9. Machine, in accordance with claim 8, characterised because it consists of at least two of these drop channels (33) located under the associated open spaces (32), on either side of this area (Z) of the linear conveyor (20) in the described positioning station (30), with the displacing device (31) operating to alternately distribute articles (A) towards the described open spaces (32), of which there are at least two.

10. Machine, in accordance with claim 9, characterised because these end-stops (34a, 34b) and/or front support element (35) are associated with the displacing element (31), moving together with it.

11. Machine, in accordance with claim 9, characterised because these end-stops (34a, 34b) and/or front support element (35) are stationary and extend in a continuous manner over the same front parts of both open spaces (32) and over the front part of this area (Z) of the linear conveyor (20) at the positioning station (30).

12. Machine, in accordance with claim 10 or 11, characterised because the displacing element (31) consists of at least one vertical longitudinal wall (37), either solid or hollow, connected to alternate sideways means of operation, such as a fluid dynamic cylinder (38), the wall (37) of which is at least as thick as the separations between the conveyor (20) and each of the open spaces (32).

13. Machine, in accordance with claim 12, characterised because this vertical longitudinal wall (37) is joined to other walls which make up two compartments (37a), one on each side of the wall (37), moveable transversely, and with at least its entrances and bottom open.

14. Machine, in accordance with any of claims 7 to 13, characterised because it consists of the means to adjust the positioning station (30) to various types of articles (A) of different dimensions, and because these means of adjustment consist of an upper section of the drop channel (33), in the form of a funnel, made up of two halves (33a, 33b) partially overlapping that can be fixed in at least two mutually relative, different positions.

15. Machine, in accordance with any of claims 7 to 13, characterised because it consists of the means to transfer (50) articles (A) from the same drop channels (33) of the positioning station (30) to this exit conveyor (40) for articles (A) orientated in a vertical, aligned position.

16. Machine, in accordance with claim 15 when it depends on claim 9, characterised because these means of transfer (50) consist of a displacing element (51) to transfer the articles (A) in an alternate transversal direction from each of the described drop channels (33) to the reception area of the exit conveyor (40), where the reception area is located between the two drop channels (33).

17. Machine, in accordance with claim 16, characterised because this displacing element (51) consists of two adjacent compartments (51a), with their upper, lower and front sides open, and each is capable of being located under a corresponding drop channel (33), forming a lower section of the same and over the reception area of the exit conveyor (40).

18. An automatic linear machine for article positioning and aligning, where these articles (A) are of the type with a differentiated geometric configuration (A1) at one of its ends, such as bottles with necks, where the machine consists of:
a container (10) of these articles (A) in a disordered bulk manner;
a linear conveyor (20) for these articles (A) coming from this same container in a low position, pre-orientated in a longitudinal direction, with this differentiated geometric configuration (A1) located either to the front or rear with respect to the direction of travel of conveyor (20);
a positioning station (80) for these articles (A) in a vertical orientation associated with conveyor (20);
an exit conveyor (40) for the articles (A) orientated in a vertical, aligned position, characterised because:
this linear conveyor (20) is associated with selectors (70), which are located before this positioning station (80), in order to remove from the conveyor or turn through 180° those articles (A) which arrive with the described differentiated geometric configuration (A1) located in an unwanted front or rear position, so that the articles (A) are fed to the positioning station (80) with the differentiated geometric configuration (A1) always located in the desired position with respect to the direction of travel.

19. Machine, in accordance with claim 18, characterised because these selectors (70) incorporate detectors (71), such as an electronic reader, optical sensors, video camera or similar, to detect the position of the differentiated geometric configuration (A1) in articles (A) which are moving along the conveyor (20) and which, on detecting an article (A) with the differentiated geometric configuration (A1) in an unwanted position, will issue a command to a rejection device (72), such as a pusher driven by a fluid dynamic cylinder, which pushes this detected article (A) off the conveyor (20).

20. Machine, in accordance with claim 18, characterised because these selectors (70) consist of detectors (71), such as an electronic reader, optical sensors, video camera or similar, to detect the position of the differentiated geometric configuration (A1) in articles (A) which are moving along the conveyor (20) and which, on detecting an article (A) with the differentiated geometric configuration (A1) in an unwanted position, will issue a command to a turning device (73), which then rotates this detected article (A) through 180° on the conveyor (20).

21. Machine, in accordance with claim 18, characterised because the positioning station incorporates the means to take the articles (A), which are all advancing with the geometric configuration (A1) in the desired position, to at least one open space over at least one drop channel with an open bottom through which the articles (A) are located in the vertical position over the exit conveyor (40).

22. Machine, in accordance with claim 18, characterised because the positioning station (80) includes a rotating element (81) fitted with cavities (82) each of which is suitable for receiving an article (A) in a substantially radial arrangement and with the geometric configuration (A1) in the desired position, where the rotating element (81) on turning, will deposit articles (A) by gravity in a vertical position over the exit conveyor (40).

23. Machine, in accordance with claim 22, characterised because in the entry conveyor (20), at the entrance to the positioning station (80), is a moving retaining device (22), such as the shaft of a fluid dynamic cylinder, which momentarily retains each article (A), while the rotating element (81) rotates to carry away the previous article (A) and locates another empty cavity (82) in front of the momentarily retained article (A).

24. Machine, in accordance with claim 22, characterised because is consists of a delivery device (90) for sequentially positioning pucks (91) for articles (A) over this exit conveyor (40), in the area where the rotating element (81) turns to deposit articles (A) by gravity in a vertical position, so that each of these articles (A) is deposited inside one of these pucks (91), which is then moved on by the exit conveyor (40).

25. Machine, in accordance with claim 24, characterised because these means of positioning (90) and the described rotating element (81) are synchronically driven by motors (92), and fitted with detectors (88), such as an optical sensor, to detect the presence of an article (A) in the cavity (82) when it is filled, this operation only occurs when the presence of an article (A) in cavity (82) on being filled is detected.

26. Machine, in accordance with claim 22, characterised because the rotating element (81) turns in such a direction that articles (A) pass through an inverted vertical position before being deposited on the exit conveyor (40).

27. Machine, in accordance with claim 26, characterised because these cavities (82) have at least one cylindrical wall (83) coaxial to the shaft of the rotating element (81) the cylindrical wall of wall (83) of which supports part of article (A) with an aperture that communicates with a hollow cavity on the same, with at least one aperture (84) in this same cylindrical wall (83) aligned with the apertures of the articles, which, during the turning of the rotating element (81) pass through an area where they face a cleaning liquid blower nozzle (85) or with a suction nozzle (86), or both consecutively through the aperture (84).

28. An automatic linear machine for article positioning and aligning, where these articles (A) are of the type with a differentiated geometric configuration (A1) at one of its ends, such as bottles with necks, where the machine consists of:
a container (10) of these articles (A) in a disordered bulk manner;
a linear conveyor (20) for these articles (A) coming from this same container in a low position, pre-orientated in a longitudinal direction, with this differentiated geometric configuration (A1) located either to the front or rear with respect to the direction of travel of conveyor (20);
a positioning station (30) for these articles (A) in a vertical orientation associated with conveyor (20);
an exit conveyor (40) for the articles (A) orientated in a vertical, aligned position,
characterised because it also consists of:
a feeder (60) to feed articles (A) from this container (10) to the described linear conveyor (20) in this same pre-orientated position, where feeder (60) consists of at least a first and second inclined planes (61, 62) to receive articles (A) in a disordered manner, coming from container (10), where the first and second inclined planes (61, 62) converge in a drop space (63) delimited by two vertical parallel planes (64) separated by a distance that is slightly longer than the smallest transverse dimension of articles (A), where the drop space (63) is arranged aligned over a portion of the linear conveyor (20);
and because this positioning station (30) consists of:
an end-stop (34a) located in the path of conveyor (20) to detain the advance of an article (A) in an area (Z) of the same with the described differentiated geometric configuration (A1) of article (A) in front of a reference line (R) when this configuration (A1) is at the front of the advance, and an end-stop (34b) located in the path of this conveyor (20) to detain the advance of an article (A) in an area (Z) of the same with the opposite end (A2) of article (A) at this reference line (R) when this opposite end (A2) es is at the front of the advance;
a displacing element (31) for articles (A) in a transversal direction from this area (Z) of conveyor (20) to at least one open space (32) over at least one drop channel (33); and
some means of support located on at least some of the edges of this open space (32) in order to support this differentiated geometric configuration (A1) during the drop of article (A) into this same drop channel (33) according to the position of this configuration (A1) of article (A) with respect to the direction of travel.

29. An automatic linear machine for article positioning and aligning, where these articles (A) are of the type with a differentiated geometric configuration (A1) at one of its ends, such as bottles with necks, where the machine consists of:
a container (10) of these articles (A) in a disordered bulk manner;
a linear conveyor (20) for these articles (A) coming from this same container in a low position, pre-orientated in a longitudinal direction, with this differentiated geometric configuration (A1) located either to the front or rear with respect to the direction of travel of conveyor (20);
a positioning station (80) for these articles (A) in a vertical orientation associated with conveyor (20);
an exit conveyor (40) for the articles (A) orientated in a vertical, aligned position, characterised because it also consists of:
a feeder (60) to feed articles (A) from this container (10) to the described linear conveyor (20) in this same pre-orientated position, where feeder (60) consists of at least a first and second inclined planes (61, 62) to receive articles (A) in a disordered manner, coming from container (10), where the first and second inclined planes (61, 62) converge in a drop space (63) delimited by two vertical parallel planes (64) separated by a distance that is slightly longer than the smallest transverse dimension of articles (A), where the drop space (63) is arranged aligned over a portion of the linear conveyor (20); and
selectors (70) associated with this linear conveyor (20), located between the container (10) and the described positioning station (80), to remove from the conveyor or to rotate through 180°, those articles (A) that arrive with this differentiated geometric configuration (A1) located in an unwanted position, either front or rear, so that the articles (A) are fed to the positioning station (80) with the differentiated geometric configuration (A1) always located in the desired position;
and because the positioning station (80) includes a rotating element (81) fitted with cavities (82) each of which is suitable for receiving an article (A) with the geometric configuration (A1) in the desired position, where the rotating element (81) rotates at a speed that is suitable for the linear conveyor (20) feed frequency, which on turning, will deposit articles (A) in a vertical position over the exit conveyor (40).

30. Machine, in accordance with claim 28 or 29, characterised because this first inclined plane (61) of feeder (60) consists of an inclined rotating disc (68) which receives articles (A) from container (10) at its highest level and takes them to the mouth area of this drop space (63), which is adjacent at its lowest level, and a fixed side wall 69, arranged around part of the rotating disc 68 edge in order to delimit a space over itself.
